(19) United States
(12) Patent Application Publication
(10) Pub. No.: US 2017/0205564 A1
(43) Pub. Date: Jul. 20, 2017

(54) Light-Emitting Diode Strip, Backlight Source Unit and Display Device

(71) Applicants: BOE Technology Group Co., Ltd., Beijing (CN); HEFEI Xinsheng Optoelectronics Technology Co., Ltd., Hefei City (CN)

(72) Inventors: Xiong Xiong, Beijing (CN); Hengzhen Liang, Beijing (CN); Xiaozhe Zhang, Beijing (CN)

(21) Appl. No.: 15/272,990

(22) Filed: Sep. 22, 2016

(30) Foreign Application Priority Data
Jan. 14, 2016 (CN) 201610025566.9

(51) Int. Cl. F21V 8/00

(52) U.S. Cl. CPC G02B 6/0073; G02B 6/0055; G02B 6/0025

(57) ABSTRACT

A LED strip, a backlight source unit and a display device are provided. The LED strip includes a circuit board, a plurality of LEDs provided on the circuit board, a film stack provided on the circuit board and covering the LEDs, the film stack being configured to convert the light emitted from the LEDs into a uniform surface light source.

This application claims priority to and the benefit of Chinese Patent Application No. 201610025566.9 filed on Jan. 14, 2016, which application is incorporated herein in its entirety.

### TECHNICAL FIELD

Embodiments of the present disclosure relate to a light-emitting diode (LED) strip, a backlight source unit and a display device.

### BACKGROUND

A light emitting diode has advantages, such as small size, low power consumption, long life and the like, it has been used as a light source in a backlight source unit.

### SUMMARY

Embodiments of the present disclosure provide a light-emitting diode (LED) strip, a backlight source unit and a display device which could improve the Hot Spot effect in display.

According to at least one embodiment of the present disclosure, a light-emitting diode (LED) strip is provided, including: a circuit board; a plurality of LEDs provided on the circuit board; and a film stack provided on the circuit board and covering the LEDs, the film stack being configured to convert light emitted from each LED into a uniform surface light source.

For example, the film stack includes a first film, a second film and a third film provided on the LEDs sequentially; the first film is configured to enlarge angle of the light emitted from each LED; the second film is configured to convert the light outgoing from the first film into a uniform surface light source; and the third film is configured to decrease the emitting angle of the surface light source outgoing from the second film.

For example, the first film, the second film and the third film are arranged in a shape of semi-circle with an identical center and different radii.

For example, the first film includes a first substrate and first protrusions provided at a side of the first substrate facing the LEDs, the first protrusions being configured to refract the incident light.

For example, the second film is a diffusion film.

For example, the third film includes a second substrate and second protrusions provided on a side of the second substrate away from the second film, the second protrusions being configured to converge the incident light.

For example, each first protrusion is a triangle in cross section.

For example, each second protrusion is a triangle in cross section.

For example, the film stack is connected to the circuit board permanently.

According to embodiments of the present disclosure, a backlight source unit is provided, including at least one of the LED strip.

For example, the backlight source unit includes a light guide plate; the LED strip being provided at the incident side of the light guide plate.

For example, the backlight source unit further including a reflector sheet provided at a side of the light guide plate opposite to the emitting side.

According to embodiments of the present disclosure, a display device is provided, including a display panel and the backlight source unit.

### BRIEF DESCRIPTION OF THE DRAWINGS

Embodiments of the present disclosure will be described in more detail as below in conjunction with the accompanying drawings to enable those skilled in the art to understand the present disclosure more clearly, in which,

FIG. 1 is a schematic sectional view of a LED strip;

FIG. 2 is a schematic sectional view of a LED strip provided by an embodiment of the present disclosure in its longitudinal direction;

FIG. 3 is a schematic top view of a LED strip provided by an embodiment of the present disclosure;

FIG. 4 is a schematic sectional view of a LED strip provided by an embodiment of the present disclosure in its width direction;

FIG. 5 is a structural schematic view showing a first film, a second film and a third film provided by an embodiment of the present disclosure;

FIG. 6 is a structural schematic view of a backlight source unit provided by an embodiment of the present disclosure;

FIG. 7 is the second structural schematic view of a backlight source unit provided by an embodiment of the present disclosure;

FIG. 8 is the third structural schematic view of a backlight source unit provided by an embodiment of the present disclosure.

### DETAILED DESCRIPTION

Embodiments of the present disclosure will be described in details in connection with the drawings related to the embodiments of the present disclosure. It is apparent that the described embodiments are just a part but not all of the embodiments of the present disclosure. Based on the described embodiments herein, an ordinary skill in the art can obtain other embodiment(s), without any inventive work, which should be within the scope of the present disclosure.

Unless otherwise defined, all the technical and scientific terms used herein have the same meanings as commonly understood by one of ordinary skill in the art to which the present disclosure belongs. The terms, such as “first,” “second,” or the like, which are used in the description and the claims of the present application, are not intended to indicate any sequence, amount or importance, but for distinguishing various components. The terms, such as “comprise/comprising,” “include/including,” or the like are intended to specify that the elements or the objects stated before these terms encompass the elements or the objects and equivalents thereof listed after these terms, but not preclude other elements or objects. The terms, “on,” “under,” or the like are only used to indicate relative position relationship, and when the position of the object which is described is changed, the relative position relationship may be changed accordingly.

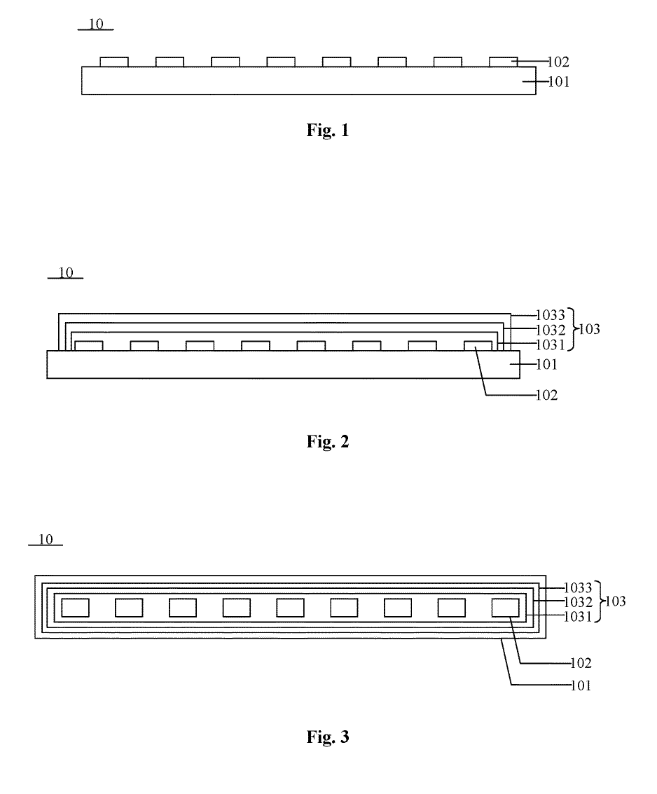

As shown in FIG. 1, the LED strip 10 of a backlight source unit includes a circuit board 101 and LEDs 102 provided on the circuit board and arranged at a distance. The inventors noticed that, due to the interval arrangement of the LEDs 102 and the LEDs 102 being dot-like light emitter, partial or intermittent shadows will be presented at an emitting side of the backlight source unit, that is, the so-called Hot Spot phenomenon. Furthermore, the electro-static discharge (ESD) of the LEDs will also result in the Hot Spot phenomenon.

An embodiment of the present disclosure provides a LED strip, as shown in FIGS. 2-3, the LED strip 10 includes a circuit board 101, a plurality of LEDs 102 provided on the circuit board. It can further include a film stack 103 provided on the circuit board 101 and covering the LEDs 102, the film stack 103 being used to convert the light emitted from all of the LEDs 102 into a uniform surface light source. For example, the film stack can be connected to the circuit board permanently. The pluralities of LEDs 102 are provided in the longitudinal direction of the circuit board 101 in a line, for example.

It is understood that, according to the function of each of the films in the film stack 103, the films can be disposed on the LEDs 102 in sequence, in such a way that the light emitted from all of the LEDs 102, when passing through the furthest film from the LEDs 102, is a uniform surface light source.

FIGS. 2-3 only schematically illustrates that the film stack 103 includes three films, however, the embodiments of the present disclosure are not limited thereto, they can be determined according to the function of each of the films.

The circuit board 101 is in electrical connection with the LEDs 102, and the function of the circuit board 101 is to drive the LEDs 102 to emit light. The circuit board 101 can be a printed circuit board (PCB), for example, and can also be a flexible printed circuit board (FPC).

The films of the film stack 103 can be secured or attached to the circuit board 101 through various ways, such as adhesive, clamping, or the like, however, the embodiments of the present disclosure are not limited thereto.

The embodiment of the present disclosure provides a LED strip 10, which, by providing a film stack 103 on the LEDs 102 and covering all of the LEDs 102, can adjust the light emitted from each of the LEDs 102, so that the light emitted from all of the LEDs 102 can be converted into a uniform surface light source in its entirety and the Hot Spot phenomenon can be avoided.

For example, as shown in FIGS. 2-3, the film stack 103 include a first film 1031, a second film 1032 and a third film 1033 provided on the LEDs 102 in sequence.

The first film 1031 is used to enlarge the angle of the light emitted from the LEDs 102, the second film 1032 is used to convert the light outgoing from the first film 1031 into a uniform surface light source, and the third film 1033 is used to decrease the emitting angle of the surface light source outgoing from the second film 1032.

Here the structure of the first film 1031 should be configured in such a way that, when the light emitted from the LEDs 102 pass through the first film 1031, the outgoing probability of the light in every directions should be improved. The structure of the second film 1032 should be configured in such a way that the point light source can be converted into a surface light source so that all of the light sources are uniformed. As to the structure of the third film 1033, it should be configured in such a way that the emitting angle of the surface light source can be reduced into a desirable emitting angle.

With the embodiment of the present disclosure, the first film 1031 is used to enlarge the emitting angle of the LEDs 102 so that the outgoing probability of the light in every directions can be improved, and on such a basis, the second film 1032 is used to diffuse the light so that the light can be converted into a surface light source and is uniformed, then the light passes through the third film 1033 such that the angle of the light emitted from the LED strip 10 can be limited into a desirable range. On this basis, only three levels of films are required which are sufficient to convert the light emitted from all of the LEDs 102 into a uniform surface light source, so the present structure is simplified.

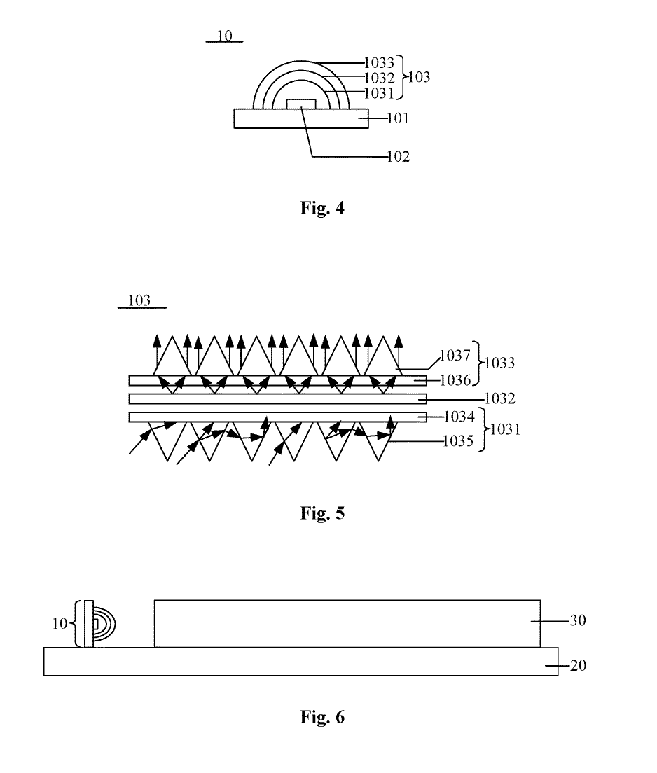

For example, as shown in FIG. 4, the first film 1031, the second film 1032 and the third film 1033 are arranged in a semi-circle with an identical circle center and different radii.

By providing all levels of the films in a form of semi-circles with an identical circle center and different radii, it is possible to maximally refract the light emitted from the LEDs 102 when passing through the first film 1031 so as to enable improving the light exiting ratio of the light in all directions, and on such a basis, the light can be increasingly uniformed after passing through the second film 1032, then, the light passes through the third film 1033 so as to further allow the brightness of the light even more uniform.

Based on the above, the first film 1031 can be any structures made based on the light refraction principle. As shown in FIG. 5, the first film 1031 may include a first substrate 1034 and first protrusions 1035 provided on a side of the first substrate 1034 facing the LEDs 102, and the first protrusions 1035 are used to refract the incident light.

Referring to FIG. 5, a part of the light emitted from the LEDs 102 is refracted by first protrusions 1035 to be directly incident to the second film 1032, another part of the light is first refracted between different first protrusions 1035, and is finally incident onto the second film 1032, so that the light can enter the second film 1032 in various directions.

The second film 1032 may be any structures made based on a diffusing principle, so that the point light source is converted into a surface light source and is thus uniformed. Based on this, the second film 1032 could be a diffusion film.

The third film 1033 can also be any structures made based on light refraction principle.

Based on this, as shown in FIG. 5, the third film 1033 includes a second substrate 1036 and second protrusions 1037 provided on a side of the second substrate 1036 away from the second film 1036, the second protrusions 1037 are used to converge the incident light.

In this way, through the convergence of the light by the third film 1033, the light brightness of the LED strip 10 can also be improved while the angle of the light emitted from the LED strip 10 can be limited within a desired range, thus the power consumption can be reduced.

It is noted that, FIG. 5 only schematically shows that the first protrusions 1035 and the second protrusions 1037 are triangles in cross section, the embodiments of the present disclosure are not limited thereto, other shapes, such as arcs or other polygons, are also possible.

The embodiments of the present disclosure also provide a backlight source unit. As shown in FIG. 6, the backlight source unit includes at least one of the LED strips 10.

Furthermore, the backlight source unit may further include a backplate 20. The led strip 10 is provided at the bottom plate of the backplate 20.

In the embodiments of the present disclosure, due to the light emitted from the led strip 10 being a uniform surface light source, the light emitting effect of the backlight source unit is excellent.

For example, the backlight source unit is a side-light-type backlight source unit.

In this case, as shown in FIG. 6, the backlight source unit further includes a light guide plate 30 which is also provided on the bottom plate of the backplate 20, and the LED strip 10 is provided on the incident side of the light guide plate 30.

It is possible that one LED strip 10 is provided; however, it is also possible that two LED strips 10 are provided. When two LED strips 10 are provided, the two LED strips 10 are provided at the opposite incident sides of the light guide plate 30.

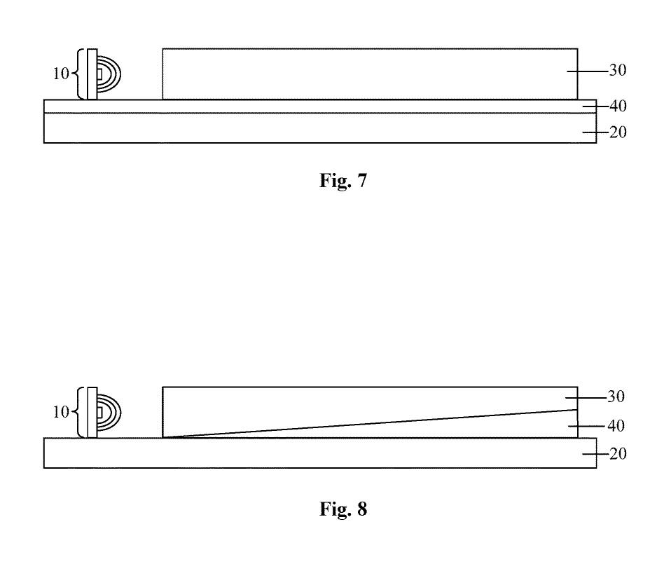

For example, as shown in FIGS. 7-8, the backlight source unit may further include a reflector sheet 40 provided at a side of the light guide plate opposite to the emitting side.

Herein, the light guide plates 30 of different shapes could employ the following positional relationships relative to the LED strip 10 and to the reflector sheet 40.

In an instance that the light guide plate 30 is flat, referring to FIG. 7, the light guide plate 30 and the LED strip 10 are provided side by side above the reflector sheet 40.

In an instance that the light guide plate 30 is wedge-shaped, as shown in FIG. 8, in the direction along which the light emitted from the LED strip 10 enters the light guide plate, the side of the light guide plate 30 being thicker is provided at a side closer to the LED strip 10, while another side of the light guide plate 30 being thinner is provided at a side away from the LED strip. Herein, in order to convert the light, incident into the light guide plate 30 from the LED strip 10, into a surface light source perpendicular to the bottom plate of the backplate 20, the horizontal surface of the light guide plate 30 is provided at a side away from the bottom plate of the backplate 20, and the angled surface of the light guide plate 30 is provided on the upper surface of the reflector sheet 40, and the shape of the reflector sheet 40 is a wedge-shaped plate matching with that of the light guide plate 30.

The backlight source unit may further include an optical film provided above the light guide plate 30 so as to perform optical improvements of different objects.

The embodiment of the present disclosure also provides a display device including a display panel and the backlight source unit.

Since the LED strip 10 in the backlight source unit provided above emits uniform light rays, for example, it is possible to improve the Hot Spot phenomenon. When it is applied in a display device, the overall display quality of the display device can be improved.

For a display panel, it may include an array substrate, a cell-assembled substrate and a liquid crystal layer between the two substrates.

The array substrate includes a base substrate, and a thin film transistor and a pixel electrode provided on the substrate plate. The thin film transistor includes a gate electrode, a gate insulating layer, a semiconductor active layer, a source electrode and a drain electrode, the drain electrode being in an electric connection with the pixel electrode. For example, the array substrate may further include a common electrode.

For an in-plane switch (IPS) array substrate, the pixel electrode and the common electrode are provided in a same layer with intervals therebetween, and both of the electrodes are strip electrodes; For an advanced super dimension switching (ADS) array substrate, the pixel electrode and the common electrode are provided in different layers, the upper electrodes are strip electrodes, and the lower electrodes are plate electrodes or strip electrodes.

The cell-assembled substrate may include filtering patterns. The filtering patterns can be red filtering pattern, green filtering pattern and blue filtering pattern, or other filtering patterns formed by three other basic colors.

The above display device can be a liquid crystal display, a liquid crystal television, a digital photo frame, a cellphone, a flat computer and any products or components having display functions.

The embodiments of the present disclosure provides a LED strip, a backlight source unit and a display device, which, by providing a film stack on the LEDs and covering all of the LEDs, can adjust the light emitted from each of the LEDs 102, thereby the light emitted from all of the LEDs 102 can be converted into a uniform surface light source in its entirety and the Hot Spot phenomenon can be avoided.

The described above are only exemplarily embodiments of the present disclosure, and the present disclosure is not intended to be limited thereto. For a person of ordinary skill in the art, various modifications and improvements can be made without departing from the principle and spirit of the present disclosure, and all of which shall fall within the scope of the present disclosure.\

The present application claims the benefits and priority of the Chinese patent application No. 201610025566.9 entitled “LED Strip, Backlight Source Unit And Display Device” filed on Jan. 14, 2016, the entirety of which is incorporated herein by reference.

What is claimed is:

1. A light-emitting diode (LED) strip, comprising:
a circuit board;
a plurality of LEDs provided on the circuit board; and
a film stack provided on the circuit board and covering the LEDs, the film stack being configured to convert light emitted from each LED into a uniform surface light source.

2. The LED strip according to claim 1, wherein the film stack comprises a first film, a second film and a third film provided on the LEDs sequentially;
the first film is configured to enlarge angle of the light emitted from each LED;
the second film is configured to convert the light outgoing from the first film into a uniform surface light source; and
the third film is configured to decrease the emitting angle of the surface light source outgoing from the second film.

3. The LED strip according to claim 2, wherein the first film, the second film and the third film are arranged in a shape of semi-circle with an identical center and different radii.

4. The LED strip according to claim 2, wherein the first film comprises a first substrate and first protrusions provided at a side of the first substrate facing the LEDs, the first protrusions being configured to refract the incident light.

5. The LED strip according to claim 2, wherein the second film is a diffusion film.

6. The LED strip according to claim 2, wherein the third film comprises a second substrate and second protrusions provided on a side of the second substrate away from the second film, the second protrusions being configured to converge the incident light.

7. The LED strip according to claim 4, wherein each first protrusion is a triangle in cross section.

8. The LED strip according to claim 6, wherein each second protrusion is a triangle in cross section.

9. The LED strip according to claim 1, wherein the film stack is connected to the circuit board permanently.

10. A backlight source unit comprising at least one LED strip according to claim 1.

11. The backlight source unit according to claim 10, further comprising a light guide plate;
wherein the LED strip is provided at the incident side of the light guide plate.

12. The backlight source unit according to claim 11, further comprising a reflector sheet provided at a side of the light guide plate opposite to the emitting side.

13. A display device comprising a display panel and a backlight source unit according to claim 10.
